(19) United States
(12) Patent Application Publication
(10) Pub. No.: US 2023/0329223 A1
(43) Pub. Date: Oct. 19, 2023

(54) DISPOSABLE FOLDABLE ELECTRIC MOUSE COMPARTMENT

(71) Applicant: MING YANG, Dongguan (CN)

(72) Inventor: MING YANG, Dongguan (CN)

(21) Appl. No.: 17/659,478

(22) Filed: Apr. 15, 2022

(51) Int. Cl. A01M 23/16; A01M 23/38

(52) U.S. Cl. CPC A01M 23/38; A01M 23/16

(57) ABSTRACT

The present invention discloses a disposable foldable electric mouse compartment, comprising a compartment body and a high-voltage conductive medium, wherein the high-voltage conductive medium is mounted on the bottom surface of the inner wall of the compartment body, and the compartment body can be folded into a flat shape.

### TECHNICAL FIELD

The present invention relates to the technical field of mouse trapping and killing, and more particularly to a disposable foldable electric mouse compartment.

### BACKGROUND

Mice eat food and spread disease, and have highly reproductive power and are harmful to human beings, so eradicating mice is a long-term task for human beings. Traditional mousetrap can only trap mice, and how to deal with the trapped mice is a difficult problem. At present there are some electric mouse killers on the market that can convert AC or DC low-voltage electricity into high-voltage electricity, and the mice can be killed by corona when they encounter high voltage. However, the existing electric mouse killers are generally of an integrated structure, whose compartment bodies cannot be disassembled, which are bulky and increase the transportation cost. When the mice are electrified, urine stains and dirt will be left, which need to be cleaned every time before the electric mouse killers can be used again, which is not conducive to the health of users.

### SUMMARY

It is an object of the present invention to overcome the above defects of the prior art and to provide a disposable foldable electric mouse compartment.

In order to achieve the above object, the present invention provides a disposable foldable electric mouse compartment, comprising a compartment body and at least two high-voltage conductive media, the compartment body being provided as a hollow structure, one end of the compartment body being opened to form a mouse inlet, the other end of the compartment body being opened to form a plug-in port for connecting with the electric mouse killer main body, all the high-voltage conductive media being respectively mounted on a bottom surface of an inner wall the compartment body, and the compartment body can be folded into a flat shape.

The compartment body is composed of a top plate, a bottom plate and two side plates, the two side plates being connected between the top plate and the bottom plate to form a square structure, and the connection between the top plate and the two side plates and the connection between the bottom plate and the two side plates are respectively creased.

The compartment body is provided as a paper compartment body.

Three of the high-voltage conductive media are provided, a first high-voltage conductive medium, a second high-voltage conductive medium and a third high-voltage conductive medium being respectively arranged at intervals in a direction of the plug-in port of the compartment body, a side edge of the first high-voltage conductive medium being provided with a first medium extension portion connected to one side of the inner wall of the compartment body, a side edge of the second high-voltage conductive medium being provided with a second medium extension portion connected to the other side of the inner wall of the compartment body, and the first medium extension portion and the second medium extension portion respectively extending to the plug-in port of the compartment body.

The first high-voltage conductive medium is a high-voltage negative electrode, the second high-voltage conductive medium is a high-voltage positive electrode, and the third high-voltage conductive medium is a high-voltage negative electrode for triggering.

All of the high voltage conductive media are respectively provided as aluminum foils.

A surface of a top plate of the compartment body is provided with an arrow mark for indicating a plugging direction.

Compared to the prior art, the advantageous effects of the present invention are:

The electric mouse compartment of the present invention has a simple structure, a reasonable design, and is convenient to assemble and disassemble with the electric mouse killer main body; the high-voltage conductive medium can electrocute the mouse after being connected to the high-voltage electricity; the mouse and the electric mouse compartment can be thrown away together after the mouse is electrocuted, thereby reducing the contact with the mouse, clean and sanitary, easy to use and safe.

The electric mouse compartment of the present invention can reduce the volume after being folded and facilitate transportation and storage.

### BRIEF DESCRIPTION OF DRAWINGS

In order to explain the embodiments of the present invention or the technical solutions in the prior art more clearly, a brief description will be given below with reference to the accompanying drawings which are used in the description of the embodiments or the prior art, and it is obvious that the drawings in the description below are some embodiments of the present invention, and it would have been obvious for a person of ordinary skill in the art to obtain other drawings according to these drawings without involving any inventive effort.

FIG. 1 is a first schematic view showing a structure of a disposable foldable electric mouse compartment.

FIG. 2 is a second schematic view showing a structure of a disposable foldable electric mouse compartment.

FIG. 3 is a schematic view showing a structure of a disposable foldable electric mouse compartment after being folded.

FIG. 4 is an assembly view of an electric mouse compartment and an electric mouse killer main body.

FIG. 5 is a schematic view showing a structure of an electric mouse killer main body.

FIG. 6 is a schematic view showing an internal structure of an electric mouse killer main body.

FIG. 7 is a schematic view showing a bottom structure of an electric mouse killer main body.

### DETAILED DESCRIPTION

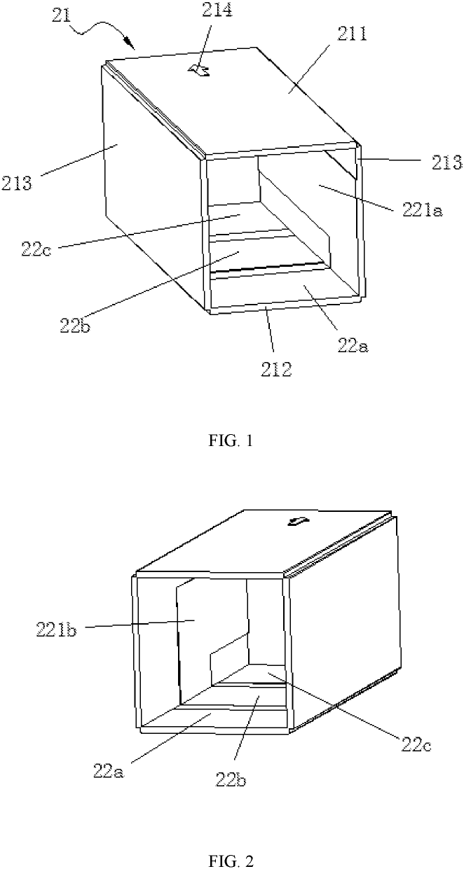

Referring to FIGS. 1 and 2, an embodiment of the present invention provides a disposable foldable electric mouse compartment, comprising a compartment body 21 and a high voltage conductive medium 22a, a high voltage conductive medium 22b and a high voltage conductive medium 22c, and various components of the embodiment will be described in detail with reference to the accompanying drawings.

The compartment body 21 is provided as a hollow structure, one end of the compartment body 21 is opened to form a mouse inlet, and the other end of the compartment body 21 is opened to form a plug-in port for connecting with the electric mouse killer main body.

Specifically, the compartment body 21 may be composed of a top plate 211, a bottom plate 212 and two side plates 213, the two side plates 213 being connected between the top plate 211 and the bottom plate 212 to form a square structure, and the connection between the top plate 211 and the two side plates 213 and the connection between the bottom plate 212 and the two side plates 213 are respectively creased.

Preferably, the compartment body 21 may be provided as a paper compartment body, which is lightweight, easy to prepare, and low in cost. Of course, according to practical requirements, the compartment body 21 may also be a disposable foldable compartment body made of other materials, such as a foldable plastic compartment body.

As shown in FIGS. 1 and 2, the high-voltage conductive media 22a, 22b and 22c are respectively mounted on the bottom surface of the inner wall of the compartment body 21; the high-voltage conductive media 22a, 22b and 22c are respectively arranged at intervals in the direction of the plug-in port of the compartment body 21; a side edge of the high-voltage conductive medium 22a is provided with a first medium extension portion 221a connected to one side of the inner wall of the compartment body 21; a side edge of the high-voltage conductive medium 22b is provided with a second medium extension portion 221b connected to the other side of the inner wall of the compartment body; and the first medium extension portion 221a and the second medium extension portion 221b respectively extending to the plug-in port of the compartment body 21.

Wherein, the high-voltage conductive medium 22a may be provided as a high-voltage negative electrode, the high-voltage conductive medium 22b may be provided as a high-voltage positive electrode, and the high-voltage conductive medium 22c may be provided as a high-voltage negative electrode for triggering.

Due to the high alertness and agility of mice, if only two high-voltage conductive media are provided, mice try to eat the bait and may escape immediately after the high voltage is triggered; and if three high-voltage conductive media are provided, even if the high-voltage conductive media 22b and 22c located inside do not electrocute the mice, the high-voltage conductive medium 22a located on the outside can also electrocute the mice running back, which is beneficial to block the retreat route of the mice, and can further improve the efficiency of electrocuting the mice.

Preferably, the high-voltage conductive media 22a, 22b and 22c may be respectively provided as aluminum foils, which are easy to assemble, light and thin, and can reduce the weight of the electric mouse compartment.

In addition, a surface of the top plate 211 of the compartment body may be further provided with an arrow mark 214 for indicating a plugging direction, which can prevent an electric mouse compartment from being misplugged.

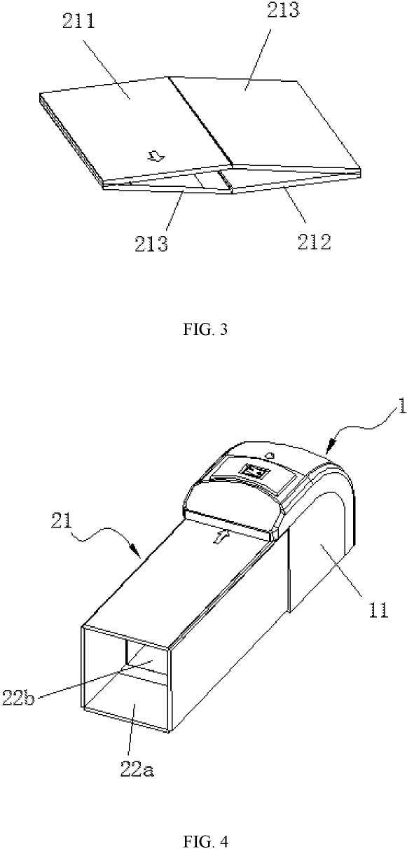

As shown in FIG. 3, the compartment body 21 may be folded into a flat shape, and the compartment body 21 can be folded to reduce the volume and facilitate transportation and storage.

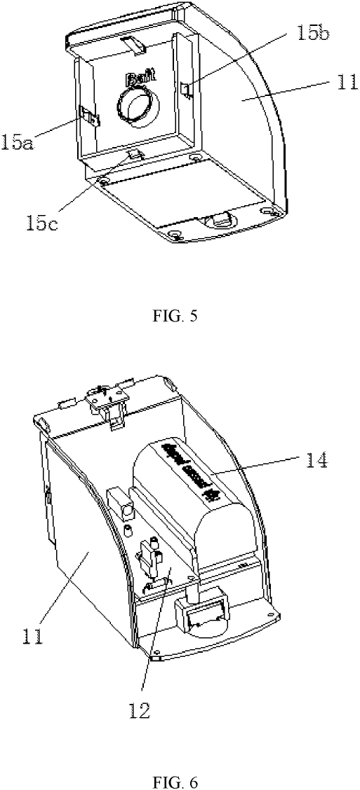

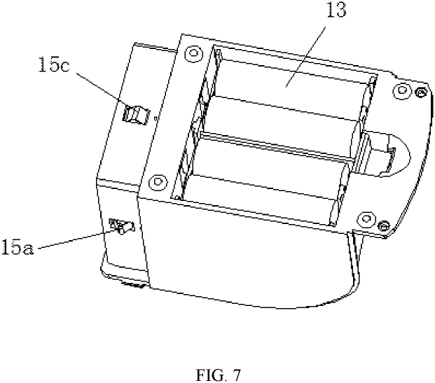

As shown in FIGS. 4 to 7, the electric mouse compartment may be connected to the electric mouse killer main body 1, and the electric mouse killer main body 1 may comprise a housing 11, a circuit board 12, a battery 13, a high-voltage pack 14 (also referred to as a high-voltage generator or a line output transformer) for generating high-voltage electricity and high-voltage contact pieces 15a, 15b and 15c; the circuit board 12 and the high-voltage pack 14 being respectively mounted inside the housing 11, the high-voltage contact pieces 15a, 15b and 15c being respectively mounted on a plug-in end of the housing 11, and the battery 13, the high-voltage pack 14 and the high-voltage contact pieces 15a, 15b and 15c being electrically connected to the circuit board 12, respectively. The high-voltage conductive medium 22a may be in contact connection with the high-voltage contact piece 15a via a first medium extension portion 221a connected to one side of the inner wall of the compartment body 21, the high-voltage conductive medium 22b may be in contact connection with the high-voltage contact piece 15b via a second medium extension portion 221b connected to the other side of the inner wall of the compartment body 21, and the high-voltage conductive medium 22c may be in direct contact connection with a third high-voltage contact piece 15c.

When the mouse enters the electric mouse compartment for food, it may firstly touch the high-voltage conductive medium 22a and the high-voltage conductive medium 22b, which may not immediately connect the high-voltage electricity; but when the mouse moves inwards further and touches the high-voltage conductive medium 22b and the high-voltage conductive medium 22c, the high-voltage conductive media 22a, 22b and 22c will connect the high-voltage electricity (e.g., 8000V), electrocuting the mouse.

In summary, the electric mouse compartment of the present invention has a simple structure, a reasonable design, and is convenient to assemble and disassemble with the electric mouse killer main body; the high-voltage conductive medium can electrocute the mouse after being connected to the high-voltage electricity; the mouse and the electric mouse compartment can be thrown away together after the mouse is electrocuted, thereby reducing the contact with the mouse, clean and sanitary, easy to use and safe; and the electric mouse compartment can reduce the volume after being folded, so as to facilitate transportation and storage.

It should be noted herein that the number of the high-voltage conductive media may be provided as two or three or more, respectively, according to practical requirements, which is not a limitation of the present embodiment.

The embodiments described above are preferred embodiments of the present invention, but the embodiments of the present invention are not limited to the embodiments described above, and any other changes, modifications, substitutions, combinations and simplifications made without departing from the spirit and principles of the present invention are to be construed as equivalent substitutions within the scope of the present invention.

What is claimed is:

1. A disposable foldable electric mouse compartment, comprising a compartment body and at least two high-voltage conductive media, wherein the compartment body is provided as a hollow structure, one end of the compartment body is opened to form a mouse inlet, the other end of the compartment body is opened to form a plug-in port for connecting with the electric mouse killer main body, all the high-voltage conductive media are respectively mounted on a bottom surface of an inner wall the compartment body, and the compartment body can be folded into a flat shape.

2. The disposable foldable electric mouse compartment of claim 1, wherein the compartment body is composed of a top plate, a bottom plate and two side plates, the two side plates being connected between the top plate and the bottom plate to form a square structure, and the connection between the top plate and the two side plates and the connection between the bottom plate and the two side plates are respectively creased.

3. The disposable foldable electric mouse compartment of claim 1, wherein the compartment body is provided as a paper compartment body.

4. The disposable foldable electric mouse compartment of claim 1, wherein three of the high-voltage conductive media are provided, a first high-voltage conductive medium, a second high-voltage conductive medium and a third high-voltage conductive medium being respectively arranged at intervals in a direction of the plug-in port of the compartment body, a side edge of the first high-voltage conductive medium being provided with a first medium extension portion connected to one side of the inner wall of the compartment body, a side edge of the second high-voltage conductive medium being provided with a second medium extension portion connected to the other side of the inner wall of the compartment body, and the first medium extension portion and the second medium extension portion respectively extending to the plug-in port of the compartment body.

5. The disposable foldable electric mouse compartment of claim 4, wherein the first high-voltage conductive medium is a high-voltage negative electrode, the second high-voltage conductive medium is a high-voltage positive electrode, and the third high-voltage conductive medium is a high-voltage negative electrode for triggering.

6. The disposable foldable electric mouse compartment of claim 1, wherein all of the high voltage conductive media are respectively provided as aluminum foils.

7. The disposable foldable electric mouse compartment of claim 1, wherein a surface of a top plate of the compartment body is provided with an arrow mark for indicating a plugging direction.
